(19) United States
(12) Patent Application Publication
(10) Pub. No.: US 2002/0163945 A1
(43) Pub. Date: Nov. 7, 2002

(54) Modulation current compensation of laser for controlled extinction ratio using dither signal

(76) Inventor: Bongsin Kwark, Irvine, CA (US)

Correspondence Address: JONES VOLENTINE, P.L.L.C., SUITE 150, 12200 SUNRISE VALLEY DRIVE, RESTON, VA, 20191, US

(21) Appl. No.: 09/897,783

(22) Filed: Jun. 29, 2001

Related U.S. Application Data
(60) Provisional application No. 60/276,230, filed on Mar. 16, 2001.

(51) Int. Cl. H01S 3/13

(52) U.S. Cl. 372/31

(57) ABSTRACT

A method of controlling an optical device includes inputting a dither current to the optical device, calculating a ratio of a first slope of a first characteristic curve to a second slope of a second characteristic curve, and calculating a modulation current based on the ratio.

An apparatus for controlling an optical device includes a driver, which inputs a dither current. The apparatus also includes a controller. The controller calculates a first slope of a first characteristic curve, a second slope of a second characteristic curve, and a modulation current.

### FIELD OF THE INVENTION

The invention relates generally to optical communications, and specifically to a method and apparatus for maintaining the extinction ratio and average optical output power of a laser device over time and temperature variations.

### BACKGROUND OF THE INVENTION

Digital fiber-optic communications have gained widespread acceptance for both telecommunications and data communication applications. Telecommunication systems typically operate over single mode fiber at distances from 10 kilometers to over 100 kilometers and employ lasers emitting at wavelengths of 1310 nm or 1500 nm. Data communication systems typically cover shorter distances of up to a few kilometers, often over multi-mode fiber. Data communication systems can employ laser devices as well, typically having emission wavelengths of 650 nm to 850 nm. As the data rates of the transmission in the telecommunications and data communications industries continue to increase, there are ever increasing demands placed on the various components of the optical communication system.

In modern optical communications, an optical carrier signal is often digitally modulated. As can be appreciated, this digital modulation results in a series of “high” (digital “one” bit) and “low” (digital “zero” bit) power outputs by the laser device. As can be appreciated, it is important to maintain respective optical output the power levels of the digital “high” and digital “low”. To this end, at the receiver end, the received optical signal is converted to an electrical signal. The digital “high” corresponds to a particular voltage level, while the digital “low” corresponds to another voltage level. If, for some reason, the optical power is not maintained at a suitable level such that the converted electrical signal is not above a particular threshold for a digital “high”, or the optical output power of a digital “low” is not sufficiently low that the electrical signal is below a particular threshold, errors in the signal transmission may result. These errors are ultimately manifest in unacceptable bit error ratios (BER).

As can be appreciated, it is useful to constantly monitor the output of an optical transmitter, such as an optical laser to ensure that the optical signal transmitted has output power levels for digital “highs” and “lows” that are at certain power levels. One measure of the output of a laser is known as the extinction ratio. The extinction ratio is a measure of the amplitude of the digital modulation on the optical carrier. The extinction ratio is defined as the average optical power of a digital logic one bit (high) divided by the average optical energy in a digital logic zero bit (low):

$$E = \frac{{P}_{1}}{{P}_{0}} \qquad ( 1 )$$

where E is the extinction ratio; P₁ is the average optical power in a logic one bit; and P₀ is the average optical power in a logic zero bit. Standards for communication systems such as the synchronous optical network (SONET) or SDH specify minimum extinction ratio requirements for laser transmitters. Specifically, when a laser is digitally modulated for signal transmission, the extinction ratio of the modulated laser should be kept nearly constant for better transmission of the signal. Normally, there is a minimum extinction ratio requirement set by the standard, and it is important to maintain the extinction ratio of the digitally modulated laser in an optical transmission system at or above this minimum requirement. This ensures that the BER is maintained to the standard of the particular optical communication system in which the laser is deployed.

As is known, the extinction ratio may be impacted by a variety of influences in an optical communication system. Two influences are the affects of temperature and aging on a laser or other active device used for the optical signal transmission. The influences of temperature and aging on the output of the laser may be readily understood from the characteristic curves of a laser such as that shown in FIG. 1, which is a graph of the optical power versus laser current for a laser. Characteristic curve 101 is the optical output power versus laser current for a laser at a first temperature, prior to the impact of aging. Contrastingly, characteristic curve 102 is the optical power versus laser current of a laser device impacted by elevated temperature and/or aging.

Illustratively, a chosen extinction ratio (P_{I}/P₀) may be defined as shown in FIG. 1. As can be appreciated, for the laser operating along curve 101, output P₁ corresponds to a particular laser current 103; and optical output power P₀ corresponds to a particular laser current 104. However, as the laser ages and/or is subject to an increased temperature, it illustratively operates along characteristic curve 102. If the laser current levels are maintained at 103 for the optical power of a logic one bit, and at laser current level 104 for a logic zero bit, the output of the laser operating along characteristic curve 102 will be significantly reduced. Specifically, the output power for a logic one bit will be P₁′, and the output power for a logic zero bit will be P₀′, as is shown in FIG. 1. As can be readily appreciated, the extinction ratio

$$( \frac{{P}_{1}^{′}}{{P}_{0}^{′}} )$$

will be reduced to unacceptable levels. Accordingly, the bit error ratio will be unacceptably low, and transmission of voice and data may be severely impacted.

Moreover, it is often useful to maintain the average power of the optical signal at a predetermined level. Illustratively, this average power is the average of the optical power of a logic one bit and the optical power of a logic zero bit. For example, the average optical power for a device operating along characteristic curve 101 is at a predetermined value, Pₐᵥ. This illustrative predetermined value may be one set by a particular standard. As the effects of time and aging impact a device, the average power may also be significantly impacted. For example, the average of P₁′ and P₀′ is Pₐᵥ′ which may be unacceptably low.

One conventional method of controlling an output of a laser is to incorporate a thermoelectric cooler into a laser package so as to keep the laser at a constant temperature. As such, the laser will operate along a particular characteristic curve. Accordingly, the extinction ratio can be maintained at a constant level. However, there are certain disadvantages to this approach. For example, thermoelectric coolers tend to increase the cost of the device; increase the size of laser package; and decrease the reliability of the laser, since any failure of the thermo-electric cooler or its circuitry may result in the application of an inappropriate bias current as the temperature of the laser varies. Moreover, thermoelectric coolers may be difficult to implement in a variety of environments. Finally, the thermoelectric cooler does not mitigate the effects of aging on the device, which can equally impact the extinction ratio and average output power of the device over time.

Another conventional approach to maintaining the extinction ratio of a laser is through the use of a controller which makes suitable adjustments in the bias and/or modulation current to account for the effects of time and/or temperature based on historical statistical data of the laser. These controllers may incorporate a look-up table which includes the historical statistical time and temperature data for each individual laser. While this approach has shown promise in the past, it is, nonetheless, solely dependent upon historical statistical data. Therefore, devices which have not been subjected to age and/or temperature testing, for example, cannot be compensated using this convention scheme. This is particularly problematic, since many of the devices implemented in current and next-generation high-speed applications do not have such data.

Accordingly, while conventional techniques to maintain the extinction ratio have had some success, they clearly have their shortcomings some of which are described above.

What is needed, therefore, is a technique which substantially maintains the extinction ratio of a laser by correcting for both temperature induced changes as well as age induced changes in the slope of a laser device that overcomes the shortcomings of the conventional techniques described above.

### SUMMARY OF THE INVENTION

According to an illustrative embodiment of the present invention, a method of controlling an optical device includes introducing a dither current, calculating a ratio of a first slope of a first characteristic curve to a second slope of a second characteristic curve; and calculating a modulation current based on the ratio.

According to another illustrative embodiment of the present invention, an apparatus for controlling an optical device includes a driver, which inputs a dither current. The apparatus also includes a controller. The controller calculates a first slope of a first characteristic curve, a second slope of a second characteristic curve, and calculates a modulation current.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a graphical representation of optical power versus laser current showing the effects of temperature and/or aging on a laser or other device.

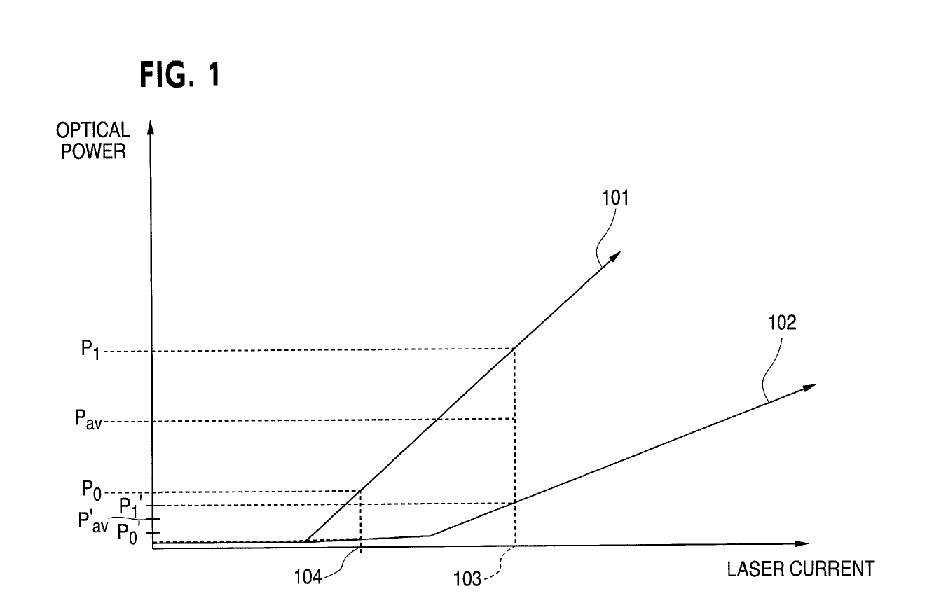

FIG. 2 is a graphical representation of optical power versus laser current showing the change in the slope of a characteristic curve of a laser due to temperature and aging effects, as well as the extinction ratio (E) and initial modulation current (I_{mod}_{_{—}}ᵢₙₜ), and required modulation current (I_{mod}_{_{—}}_{req}), in accordance with an illustrative embodiment of the present invention.

FIG. 3 is a functional block diagram of a monitor laser driver feedback loop in accordance with an illustrative embodiment of the present invention.

FIG. 4 is a flow chart of an illustrative method for measuring the slope coefficient in accordance with an illustrative embodiment of the present invention.

FIG. 5 is a flow chart of an illustrative method for modulation current compensation in accordance with an illustrative embodiment of the present invention.

FIG. 6 is a graphical representation of optical power versus laser current in accordance with an illustrative embodiment of the present invention where the dither current output (Dₜₕ_{_{—}}ₒᵤₜ) is constant for for a device operating along two distinct characteristic curves.

FIG. 7 is a flow chart of an illustrative method for calculating a slope of a characteristic curve in accordance with an exemplary embodiment of the present invention.

FIG. 8 is a flow chart of an illustrative method for modulation current compensation in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a method and apparatus for maintaining the extinction ratio and average output optical power of a digital optical signal from an optical transmitter over temperature and/or time. According to an illustrative embodiment of the present invention, a relatively small modulation current (referred to herein as a dither current) is superposed over an initial modulation current. The resultant dither output power (Dₜₕ_{_{—}}ₒᵤₜ_{_{—}}ᵢₙᵢₜ) is then measured, and the slope of the initial characteristic curve is determined. This dither current is continually introduced. If a device is affected by age and/or temperature, its characteristic curve shifts and its slope decreases.

The introduction of the dither current results in a different dither output due to the reduced slope of the characteristic curve of the time and/or age-affected laser device. This dither output may be used to calculate the slope of a characteristic curve of the laser device which has been impacted by temperature and/or aging. The ratio of the initial slope and the “temperature/age affected” slope is determined, and the required modulation current is calculated. Moreover, and independently, any required change in the D.C. bias current (ΔI_{DC} ) may also be effected to maintain the required average output optical power, Pₐᵥ_{_{—}}_{req}.

According to the above illustrative embodiment of the present invention, the extinction ratio may be maintained at a substantially constant level for the lifetime of a device and across a spectrum of temperature variations of the device. Moreover, the maintenance of the extinction ratio and average output power at substantially constant levels may be carried out without a priori knowledge of the device characteristics with respect to temperature and/or time.

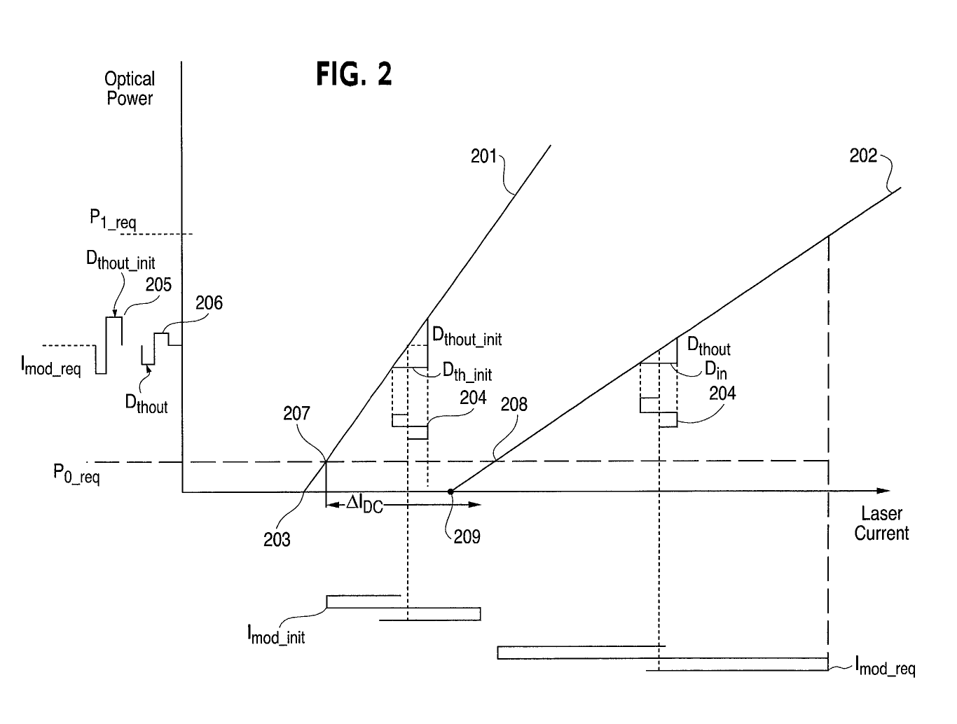

Turning to FIG. 2, the output power-versus-driver current for a laser is shown. Characteristic curve 201 represents device performance at an initial temperature. As is known, the threshold current 203 is the minimum current at which the laser turns on. Moreover, the laser operates above the threshold current level (e.g. at 207) to reduce relaxation oscillation. The laser operates substantially linearly in the operational range shown. The initial modulation current (I_{mod}_{_{—}}ᵢₙᵢₜ) modulates the laser, resulting in its operation between the required output power for a digital one bit (P₁_{_{—}}_{req}) and the output power for a digital zero bit (P₀_{_{—}}_{eq}). The ratio of these two powers (P_{_{—}}_{req}/P₀_{_{—}}_{req}) is the required extinction ratio (E) of the device. The required extinction ratio may be one set by a particular standard, such as those mentioned above.

The characteristic curve 202 is an illustrative operational characteristic curve of the same laser device after the effects of temperature and/or aging have impacted device performance. In order to maintain the required extinction ratio, the modulation current must be changed to a required modulation current (I_{mod}_{_{—}}_{eq}) as shown.

Moreover, and independently, in accordance with an exemplary embodiment of the present invention the D.C. bias current (I_{DC}) may also be changed to account for the shift in the D.C. bias due to temperature and/or aging. This ensures the required average output power, Pₐᵥ_{_{—}}_{req}, of the device is maintained. To wit, as shown at 209 on characteristic curve 202 the threshold current required to turn the laser on is increased due to the affects of aging and/or temperature. Thereafter, the laser operates in a substantially linear region of characteristic curve 202. Moreover, the laser is biased above this threshold level (e.g. at 208 of curve 202), to reduce relaxation oscillation. As such, it is necessary to increase to D.C. bias by ΔI_{DC}, (the difference between the D.C. bias current levels at 207 and 208) to maintain the extinction ratio and power at desired levels after I_{mod}_{_{—}}_{req} is derived and applied.

Therefore, in accordance with the illustrative embodiment of the present invention, not only is the extinction ratio substantially maintained, but also the average output optical power.

According to an illustrative embodiment of the present invention, the slope (C₁) of characteristic curve 201 and the slope (C₂) of characteristic curve 202 may be used in combination with the initial modulation current (I_{mod}_{_{—}}ᵢₙᵢₜ) to calculate the required modulation current (I_{mod}_{_{—}}_{req}). An illustrative method is described presently.

Turning to FIG. 2, a relatively small input dither current 204 is superposed over the initial modulation current, I_{mod}_{_{—}}ᵢₙᵢₜ. This dither current 204 results in an dither output 205 (Dₜₕₒᵤₜ_{_{—}}ᵢₙᵢₜ). From this change, the slope of initial characteristic curve 201 may be calculated as:

$${C}_{1} = \frac{{D}_{thout\_init}}{{D}_{in}} \qquad ( 2 )$$

where C₁, is the slope of initial characteristic curve 201.

Similarly, this same dither current 204 is superposed on the initial modulation current (I_{mod}_{_{—}}ᵢₙᵢₜ) when the laser is operating along characteristic curve 202 (i.e., when the effects of temperature and/or aging have shifted the D.C. bias and have reduced the slope of the characteristic curve 202). This results in an output power, Dₜₕₒᵤₜ, 206 as shown in FIG. 2. The slope of characteristic curve 202 may readily be calculated. Specifically,

$${C}_{2} = \frac{{D}_{thout}}{{D}_{in}} \qquad ( 3 )$$

where C₂ is the slope of characteristic curve 202.

Taking the ratio Of C₁ to C₂ yields

$$S = \frac{{C}_{1}}{{C}_{2}} = \frac{{D}_{thout\_init}}{{D}_{thout}} \qquad ( 4 )$$

which may be referred to as the slope coefficient (S).

The ratio of the slopes

$$\frac{{C}_{1}}{{C}_{2}} = S$$

of characteristic curves 201 and 202 may be used to scale the initial modulation (I_{mod}_{_{—}}ᵢₙᵢₜ) to its required level (I_{mod}_{_{—}}_{req}) to maintain the required extinction ratio, ER.

To this end, from straight-forward analysis:

I_{mod}_{_{—}}_{req}=(S)(I_{mod}_{_{—}}ᵢₙₜ) (5)

Once the required change in the D.C. bias current, ΔI_{DC}, and required modulation current, I_{mod}_{_{—}}_{req}, are determined, the required laser current, I_{req}, is given by:

I_{req=}I_{DC}_{_{—}}ᵢₙₜ+ΔI_{DC}+I_{mod}_{_{—}}_{req} (6)

The calculated required modulation current (I_{mod}_{_{—}}_{req}) and the appropriate change in the bias current (ΔI_{DC}) may be used to substantially maintain the extinction ratio and average output power of the device as the device ages and as temperature effects impact device performance.

Certain observations are particular noteworthy. For example, because the dither current is relatively small. As such, the dither current results in a variation in the output optical power (dither output) substantial enough to be detected at a laser monitor-photodetector, but not great enough to interfere significantly with the transmission of the main data. Illustratively, the magnitude of the dither current is approximately 3% to approximately 5% of the modulation current required. As such, the present invention may be readily incorporated into a deployed device.

Additionally, the present invention is advantageous because it does not require historical statistical data. To this end, the present invention iteratively performs the above described method, without any a priori information of the effects of aging and/or temperature on a particular laser device. This results in a substantially degree of versatility and ready deployment in operational communication systems using devices for which such data is not known.

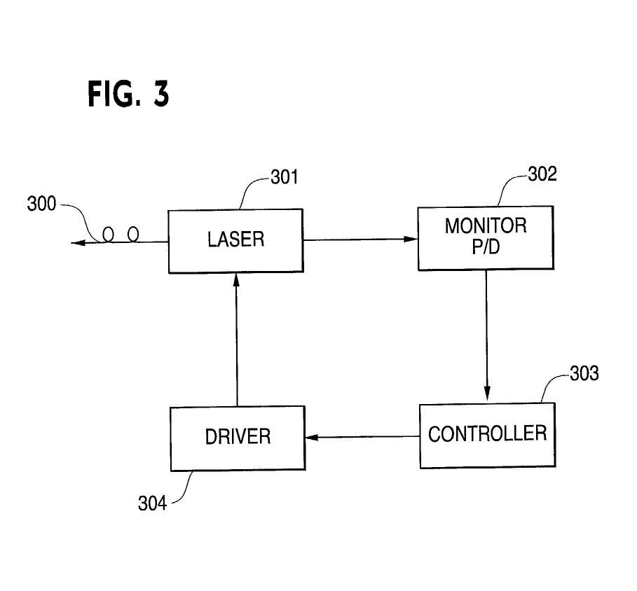

FIG. 3 is a functional block diagram of a feedback control circuit according to an illustrative embodiment of the present invention. This feedback control circuit may implement modulation current and D.C. bias current modulation schemes in accordance with illustrative embodiments of the present invention to maintain the extinction ratio and average output power of a laser at substantially constant levels. To this end, a laser 301 emits a signal to an optical fiber 300 which is connected to an optical communication system (not shown). A portion of the light from the laser 301 is impingent upon a monitor photodetector 302. Illustratively, if the laser is a semiconductor laser such as a laser diode, the rear facet of the laser emits a portion of the light that is received by the monitor photodetector 302. Alternatively, an optical tap may be used to divert a small portion of the laser output to the monitor photodetector 302.

The monitor photodetector 302 transforms the received optical signal into an electrical signal. This electrical signal is input to a controller 303, which performs the requisite calculations for C₁, C₂, S, in accordance with illustrative embodiments of the present invention. The controller 303 then issues controller commands to the driver 304 to substantially maintain ER and Pₐᵥ_{_{—}}_{req} at constant levels. The controller commands include a modulation current control and a bias current control signal. The driver 304 includes an automatic power controller (APC), which controls the D.C. bias current. Moreover the driver includes a modulation current controller, which controls the modulation current to the laser. Based on the controller commands from the controller 303, the driver 304 changes the D.C. bias current and modulation current to substantially maintain the extinction ratio of the laser 301 and the average power of the laser, each at prescribed levels of operation.

It is noted that the control apparatus and method is illustratively applied to a laser, such as a semiconductor laser. Of course, this is not intended to be limiting, but rather illustrative of the invention. Namely, the control apparatus and method of the present invention may be applied to other devices which are impacted by temperature and/or aging affects. Such devices will be within the purview of one having ordinary skill in the art.

As can be appreciated from the description above, an extinction ratio and average output power level may be predetermined for a particular application. To this end, the initial characteristic curve of a particular laser (e.g. the laser 301 in the illustrative embodiment of FIG. 3) in a deployed system is used to set the D.C. bias and modulation currents for the desired extinction ratio and average output power of the laser. For example, in the illustrative embodiment of FIG. 2, characteristic curve 201 may be the initial curve for a particular laser in a deployed system. This initial characteristic curve has a slope, C₁, and a threshold current 203 as shown in FIG. 2. Of course, it is necessary to calculate the slope, C₁, of the initial characteristic curve of the deployed laser. An illustrative method of calculating the slope of the initial characteristic curve of the laser is described presently.

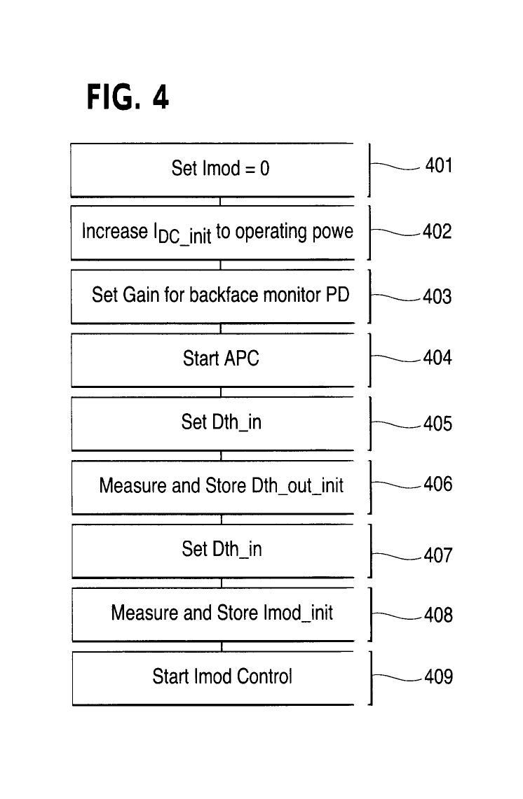

Turning to FIG. 4, a flow chart according to an illustrative embodiment of the present invention for calculating the slope of an initial characteristic curve, C₁, of a deployed laser is shown. At 401, the modulation current, I_{mod}, is set to zero as the level of I_{mod} is not yet known for a certain extinction ratio. Next, at 402, the initial D.C. bias I_{DC}_{_{—}}ᵢₙᵢₜ is set for a desired operating output optical power. Next, at 403, the gain for the backface monitor photodetector (e.g. monitor photodetector 303 of FIG. 3) is set for a measurable level. At 404, the automatic power control (APC) is started to maintain and control the D.C. bias current, I_{DC}, at the prescribed level above the threshold current.

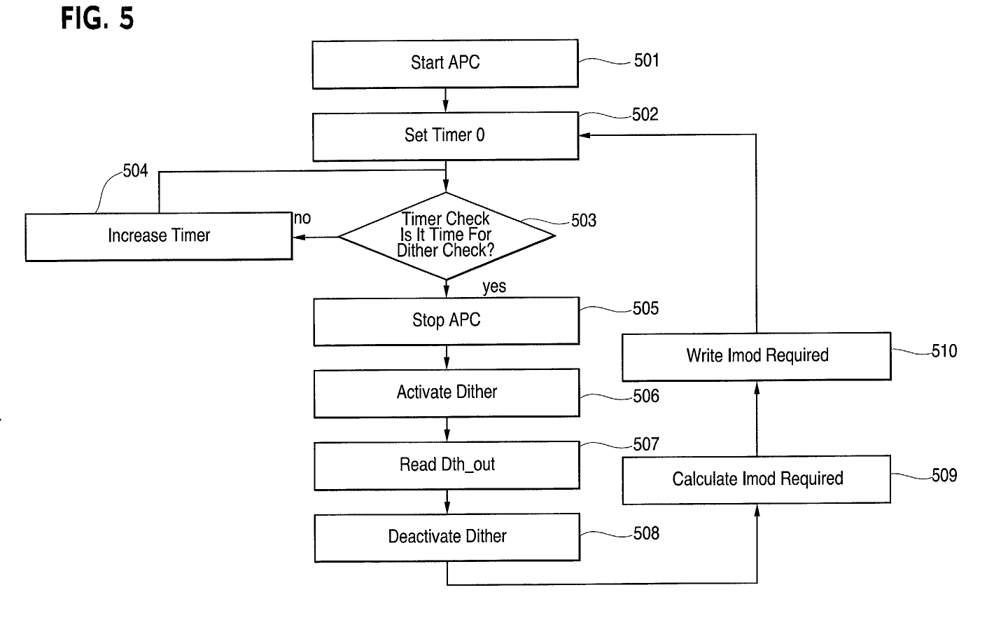

Next, at 405 the modulation current may be increased to achieve the required extinction ratio. This usually results in a decrease in I_{DO}_{_{—}}ᵢₙᵢₜ due to the automatic power control loop. At 406 the initial modulation current, I_{mod}_{_{—}}ᵢₙᵢₜ, is recorded to be used in calculation of I_{mod}_{_{—}}_{req} in conjunction with the illustrative embodiment described surrounding of FIG. 2. The initial dither input current (Dₜₕ_{_{—}}ᵢₙ) is set to approximately 3% to approximately 5% of I_{mod}_{_{—}}ᵢₙᵢₜ at 407. Illustratively, this initial dither input is a preset value which is a relatively small current perturbation which may be superposed over the modulation current in a deployed device (See for example, dither current 204 in the illustrative embodiment of FIG. 2). Next, the dither output, Dₜₕ_{_{—}}ₒᵤₜ_{_{—}}ᵢₙᵢₜ is measured and stored at 408. As explained in conjunction with the illustrative embodiment of FIG. 2, this measured dither output (Dₜₕ_{_{—}}ₒᵤₜ_{_{—}}ᵢₙᵢₜ) may be used in calculation of the slope of the initial characteristic curve, C₁. Once all of the initial settings are implemented, the I_{mod} control loop can be started at 409. This control loop is discussed in more detail in connection with FIG. 5.

Once the slope of the initial characteristic curve, C₁, is calculated, and the initial bias and modulation current values for a desired extinction ratio and average output power are known, these data may be used in subsequent calculations (e.g. C₂ and S) to make the requisite adjustments in both the D.C. bias current and modulation current at any temperature and at any age of a particular laser. As mentioned before, the D.C. bias and modulation current calculations and adjustments are made independently of one another. Advantageously, the iterative technique presently described enables the continuous compensation of the extinction ratio and average output power of a laser device over time and temperature.

Turning to FIG. 5, an illustrative method of calculating the required modulation current to maintain the extinction ratio of a laser at prescribe levels is shown. Of course, maintaining the average output power at a particular required average output power should be done in parallel and independently through the APC. The illustrative method of FIG. 5 is affected in a continual manner to account for changes in the characteristic curve of the laser due to temperature and/or aging effects.

As shown at 501, the APC is commenced. The timer is set to time equals zero (t=0) at 502. At 503, a timer check is carried out. Alternatively a temperature measurement may be made at 503. Using timer instead of temperature reading is useful in controlling I_{mod} for temperature and aging affects. If it is not necessary to compensate for aging affects, then the actual temperature of the laser device is monitored and the control of I_{mod} is based thereon. If it is desired to compensate for both the affects of aging and temperature, the timer is implemented. Illustratively, the timing period may be determined from the expect maximum rate of temperature and change of a device. Moreover, the timer may be used as a redundant device to avoid waiting too long fro the maximum affect of temperature to be realized. To wit, if too great a time interval passes to realize the affects of temperature, the affects of aging may have already been manifest, and will thus require correction. The timing period could be decided by the expected maximum rate of temperature change. (Bongsin—Please fill-in details of the timer check and the reason therefore at this point). Or timer can be used only additionally to avoid the infinite loop of temperature check even aging is in effect to degrade the slope already. Nonetheless, a determination is made whether dither control is effected at this point or not. If the decision is not to effect a dither input, an increase in the timer is effected at 504 and the loop continues as shown.

If the determination is made to activate the dither input, the APC is halted as at 505. While not required, it is useful to turn the APC off to avoid the dither signal's being cancelled by the APC. If it is desired to maintain the APC at this stage the APC time constant needs to be longer than that of the dither control. This, of course, may be controlled by the control circuitry and/or software.

The dither is activated at 5%, and a small dither input current (e.g. dither current 204 of FIG. 2) is input to the laser. At 507, the dither output (Dₜₕ_{_{—}}ₒᵤₜ) is measured. At 508, the dither circuit is deactivated, and at 509 the required modulation current, I_{mode}_{_{—}}_{req}. are calculated. The calculation of I_{mode}_{_{—}}_{req} is effected illustratively using the slope coefficient, S, described previously (c.f. eqn. (5)). Once determined, the required modulation current, I_{mode}_{_{—}}_{req} is input to the laser via the right command such as at 510.

Again, any necessary change in the D.C. bias current to compensate for the effects of temperature and/or aging may be implemented in parallel to the above method for adjusting the modulation current. To this end, the change in the D.C. bias, ΔI_{DC}, may be readily changed by having a controller (e.g. controller 303 of FIG. 3) adjust the APC of the driver 304 by a particular finite amount to account for any shift in the bias current due to the effects of temperature and/or aging.

The process described above is repeated continually. As such, any change in the input characteristics of a laser due to temperature and/or aging may be quickly compensated by the iterative method of the illustrative embodiment of the present invention in order to maintain the average output optical power and extinction ratio of a laser at a substantially constant level. Illustratively, the repetition interval of the above described illustrative method is dependent on expected maximum rate of temperature change of the laser device. Illustratively, the method is repeated at intervals of approximately a few tenths of a seconds to approximately a couple of seconds to ensure maintaining the extinction ratio.

According to the illustrative embodiment described above, a constant input dither current in introduced to effect a dither output about the required average output power. This dither output is used to calculate the slope of the initial characteristic curve as well as the slope of the characteristic curve of a device after the effects of temperature and/or aging. Of course, this is merely illustrative, and there are other techniques in keeping with the present invention to calculate the slopes of the two (or more) characteristic curves using a dither current in order to change the required modulation current as the effects of temperature and/or aging impact the performance of the laser.

Another illustrative technique includes maintaining a constant dither output, Dₜₕₒᵤₜ. In this illustrative embodiment, the dither current input, Dᵢₙ, is not the same for the device operating along different characteristic curves. Again, the dither input currents are relatively small perturbations, and may be superposed over the modulation current during operation of the device without disturbing the performance of the transmission of data during the operation of the deployed device.

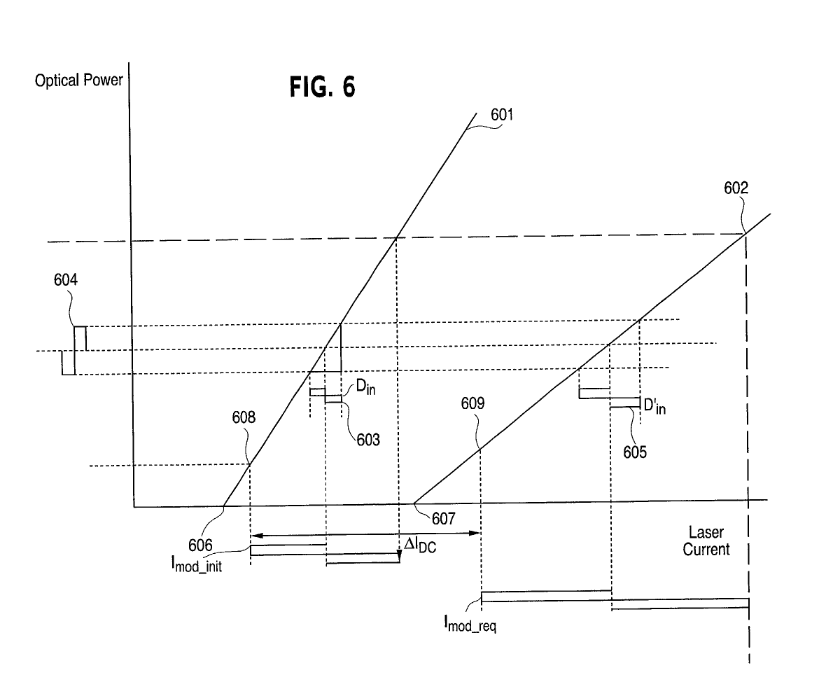

FIG. 6 is a graphical representation showing the implementation of the present exemplary method of calculating the slopes of characteristic curves in order to determine the required modulation current needed to maintain the extinction ratio at predetermined levels. Again, the average output optical power may be maintained independently by changing the D.C. bias using an APC. Characteristic curve 601 is the initial characteristic curve of a device, operating illustratively at 25° C., and before the affects of aging. As such, this becomes the calibration standard for compensating the modulation current to maintain the predetermined extinction ratio and average output power. To determine the slope of the initial characteristic curve 601, a dither input Dᵢₙ 603 is superposed over the initial modulation current I_{mod}_{_{—}}ᵢₙᵢₜ. This results in a dither output 604. Knowing the magnitude of the dither input 603 and the magnitude of the dither output 604, the slope C₁ may be readily calculated:

$${C}_{1} = \frac{{D}_{thout}}{{D}_{in}} \qquad ( 7 )$$

Next, the slope of characteristic curve 602 of the device resulting from the effects of aging and/or temperature is calculated. The desired dither output 604 is maintained, and the dither input Dᵢₙ 605 is superposed over the modulation current. This dither input current 605 is measured, and with the known level of the dither output, the slope of characteristic curve 602 is readily determined:

$${C}_{2} = \frac{{D}_{thout}}{{D}_{in}^{′}} \qquad ( 8 )$$

Next, the ratio of the slope of the initial characteristic curve 601 to the characteristic curve 602 resulting from the effects of aging and/or temperature may be calculated:

$$S = \frac{{C}_{1}}{{C}_{2}} = \frac{{D}_{in}^{′}}{{D}_{in}} \qquad ( 9 )$$

where S is the slope coefficient of characteristic curves 601 and 602.

From straightforward analysis, therefore, it can be shown:

I_{mod}_{_{—}}_{req}=(S)(I_{mod}_{_{—}}ₘₐₜ) (10)

Next, it is necessary to compensate for any change in the D.C. bias current due to aging and/or temperature effects on the laser. To this end, the laser output power becomes positive at point 606 of characteristic curve 601. This is referred to as the threshold current. Thereafter, the laser operates in a substantially linear region of the characteristic curve 601 of the laser. However, as the effects of temperature and aging impact the laser, this threshold current tends to increase. As shown at point 607 of characteristic curve 602, the threshold current required to turn the laser on is increased. Thereafter, the laser operates in a substantially linear region along characteristic curve 602. Accordingly, it is necessary to increase the D.C. bias current by this amount. This is carried out illustratively by changing the output of the APC. Again, this may be effected in parallel to any change in the modulation current required to maintain the extinction ratio by the illustrative technique describe above. To this end, as shown at 607 on characteristic curve 602, the threshold current required to turn the laser on is increased (relative to the threshold current level 606 of the laser operating along characteristic curve 601). The laser is biased above the threshold level, (e.g., at 605 of curve 601 and 606 of curve 602), to reduce the relaxation oscillation. It is necessary to therefore increase the D.C. bias current by ΔI_{DC}, which is the difference between current level 608 and current level 609, to maintain the extinction ratio and power at desired levels after I_{mod}_{_{—}}_{req} is derived and applied.

Once the required change in the D.C. bias current, ΔI_{DC}, and required modulation current, I_{mod}_{_{—}}_{req}, are determined, the required laser current, I_{req}, is given by:

I_{req}=I_{DC}_{_{—}}ᵢₙᵢₜ+ΔI_{DC}+I_{mod}_{_{—}}_{req} (11)

A feedback control circuit such as that of the illustrative embodiment of FIG. 3 may implement the iterative calculations and changes in the laser current necessary to maintain the extinction ratio and average output power of the laser, in accordance with an illustrative embodiment of the present invention. To this end, the controller 303 may effect the above captioned calculations in an iterative manner, and instruct the driver 304 to make any requisite changes in the modulation current and D.C. bias current. The driver 304 would then implement these changes in the currents to the laser 301. Again, the D.C. bias value can be implemented using APC which operated independently of the modulation current driver.

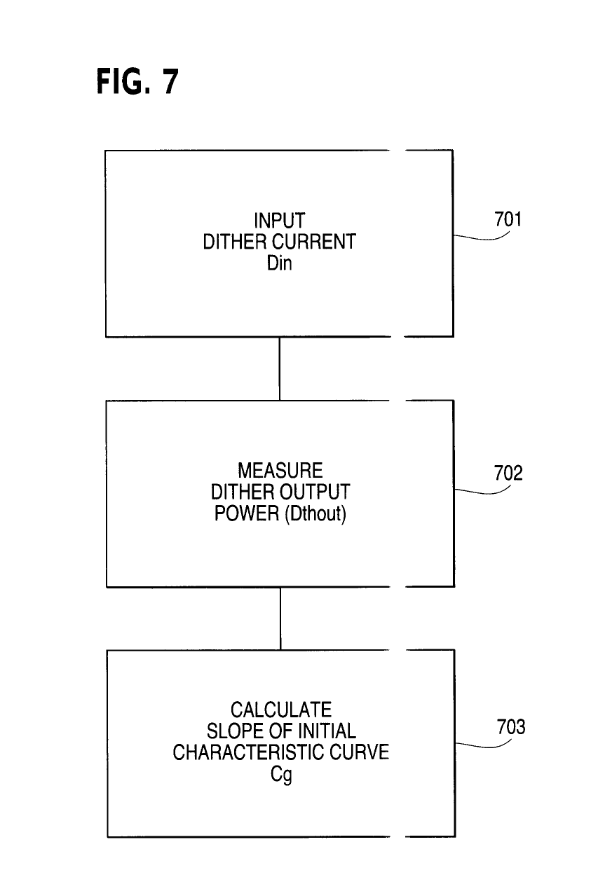

An illustrative method of calculating the slope of the initial characteristic curve 601 is shown in the flow chart of FIG. 7. At 701, the input dither current Din is input to the laser. The dither output, Dₜₕₒᵤₜ, is measured at 702. At 703, the slope C₁ of the initial characteristic curve is calculated using equation 7, referenced above. As described above, the slope C₁ of the initial characteristic curve is used as the calibration baseline for subsequent calculations of the required modulation current after the effects of temperature and/or aging impact the operation of the laser.

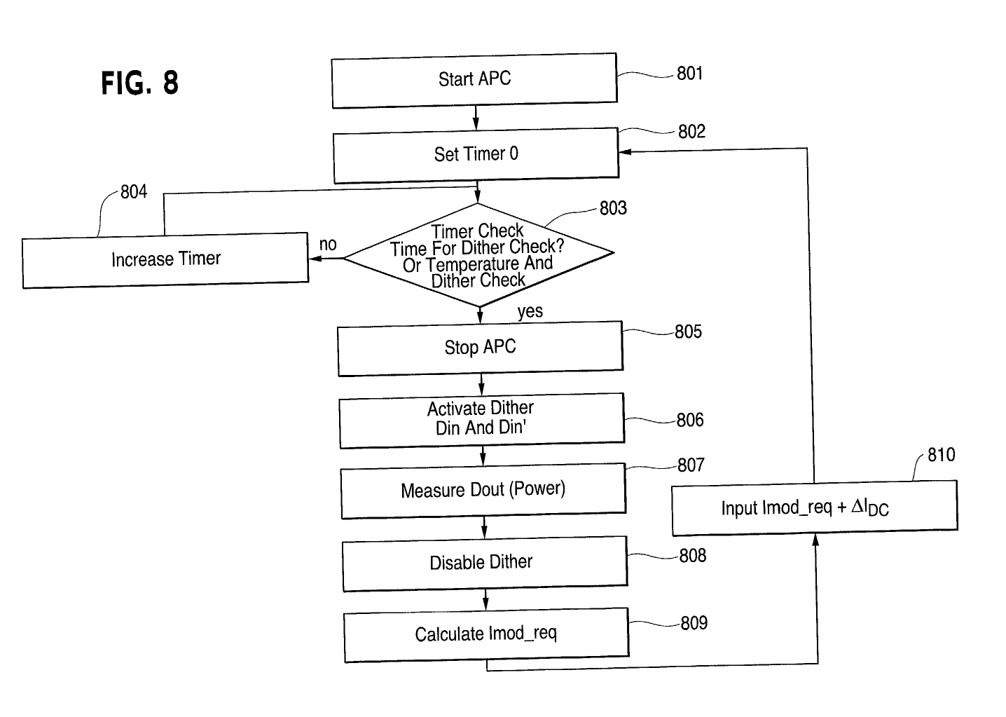

FIG. 8 shows a flow chart of an illustrative method for calculating the required modulation current according to an exemplary embodiment of the present invention. The APC is commenced at 801 as shown. Next, at 702, the timer is set to zero. At 703, a timer check is initiated. Inclusively, or alternatively, a temperature check may be carried at 803. If it is determined that a dither input is unnecessary, the timer is increased, as shown at 704. If at 803 it is determined that a dither input is to be effected, the APC is stopped at 805, and the dither is activated at 806. At this step, the input dither current, Dᵢₙ and the dither input current, D′ᵢₙ are input to effect a constant dither output, Dₜₕₒᵤₜ. The dither output is measured at 807. At 808, the dither is disabled, and at 809, the required modulation current is calculated. The calculation of the required modulation is effected by calculating the slope C₁, slope C₂, the slope coefficient, S, using equation 5, above. The required input modulation current is input at 810 to maintain the extinction ratio at a predetermined level. Again, any required change in the D.C. bias current may also be implemented at 810, independently of, and in parallel to any change modulation current.

As before, the calculation of slopes C₁, C₂, slope coefficient S, and required modulation current and D.C. bias current may be implemented in an architecture such as that shown in the illustrative embodiment in FIG. 3. To this end, the monitor photodetector 302 effects all measurements of output power and inputs the converted electrical signals therefrom to a controller 303. The controller 303 effects the calculations such as those of the illustrative methods of FIGS. 7 and 8, and sends requisite commands to the driver. The driver 304 makes any necessary changes in the modulation current as well as the required D.C. bias current to achieve the predetermined target output power, Pₐᵥ_{_{—}}_{req}, and extinction ratio, ER.

By virtue of the illustrative embodiment described in connection with FIGS. 6-8, the extinction ratio and average target output power may be maintained as desired without any a priori knowledge of the temperature and/or aging characteristics of a particular laser device. As a result of the illustrative method presently described, the extinction ratio and average power may be maintained substantially continuously and during operation.

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

I claim:

1. A method of controller an optical device, the method comprising:
introducing a dither current to the optical device;
calculating a ratio of a first slope of a characteristic curve to a second slope of a second characteristic curve; and
calculating a modulation current based on said ratio.

2. A method of controlling an optical device as recited in claim 1, wherein the method further comprises:
(a) introducing said dither current to a laser device;
(b) measuring an initial dither output power; and
(c) calculating said first slope.

3. A method as recited in claim 2, wherein the method further comprises:
(d) introducing said dither current to said laser device;
(e) measuring a dither output power;
(f) calculating said second slope; and
(g) calculating said ratio.

4. A method as recited in claim 3, wherein (d) through (g) are continually repeated.

5. A method as recited in claim 4, wherein said continual repeating is at a regular temporal interval.

6. A method as recited in claim 5, wherein said temporal interval is in the range of approximately a few milli-seconds to approximately a few seconds.

7. A method as recited in claim 1, wherein the method further comprises maintaining an average optical output power at a substantially constant level.

8. A method as recited in claim 2, wherein said first slope is given by:
$${C}_{1} = \frac{{D}_{thout\_init}}{{D}_{in}}$$

9. A method as recited in claim 3, wherein said second slope is given by:
$${C}_{2} = \frac{{D}_{thout}}{{D}_{in}} .$$

10. A method as recited in claim 1, wherein said modulation current is given by:
I_{mod}_{_{—}}_{req}=(S)(I_{mod}_{_{—}}ᵢₙᵢₜ)

11. An apparatus for controlling an optical device, comprising:
a driver which inputs a dither current to the optical device; and
a controller, which calculates a first slope of a first characteristic curve, a second slope of a second characteristic curve, and which calculates a modulation current.

12. An apparatus as recited in claim 11, further comprising a driver which changes said modulation current based on input from said controller.

13. An apparatus as recited in claim 11, wherein the optical device is a laser device.

14. An apparatus as recited in claim 11, further comprising:
a monitor detector in optical communication with the optical device.

15. An apparatus as recited in claim 11, wherein said controller continually performs said calculations at regular temporal intervals.

16. An apparatus as recited in claim 12, wherein said regular temporal intervals are in the range of approximately a few milli-seconds to approximately a few seconds.

17. An apparatus as recited in claim 12, wherein said controller commands said driver to input said dither current to the optical device.

18. An apparatus as recited in claim 17, wherein said dither current has a magnitude that is a substantially small portion of said modulation current.

19. An apparatus a recited in claim 18, wherein said substantially small portion is in the range of approximately 3% to approximately 5% of said modulation current.
